(19) United States
(12) Patent Application Publication
(10) Pub. No.: US 2022/0402657 A1
(43) Pub. Date: Dec. 22, 2022

(54) GAME BAG WITH HANDLING STRUCTURE

(71) Applicants: Troy Ray Sessions, North Pole, AK (US); Linda Gail Sessions, North Pole, AK (US)

(72) Inventors: Troy Ray Sessions, North Pole, AK (US); Linda Gail Sessions, North Pole, AK (US)

(21) Appl. No.: 17/588,046

(22) Filed: Jan. 28, 2022

Related U.S. Application Data
(60) Provisional application No. 63/142,925, filed on Jan. 28, 2021.

(51) Int. Cl. B65D 33/08; B65D 33/28; A01M 31/00

(52) U.S. Cl. CPC B65D 33/08; B65D 33/28; A01M 31/00

(57) ABSTRACT

A bag is provide for receiving and holding contents at least as heavy and bulky as a portion of a large animal carcass. The bag may configured to be carried by a person and may including a containing portion defining a closed end, an open end opposite the closed end, and a side portion interconnecting the closed end and the open end. The open end may be configured for operation between a holding configuration for holding the carcass portion in the bag and a passing configuration for passing the carcass portion through the open end. The bag may further include a closure mechanism adjacent the open end for selectively closing the open end to provide the holding configuration and opening the open end to provide the passing configuration. The bag may also define a midline between the open end and closed end and further include a handling structure positioned on the closed end side of the midline.

### FIELD OF THE DISCLOSURE

The present disclosure relates generally to bags for handling and carrying bulky, heavy, and dripping contents, such as a portion of a large animal carcass. More particularly the disclosure relates to such a bag having an open end and a closed end with a handling structure adjacent the closed end of the bag providing options for a person to lift, carry, and maneuver the bag using the handling structure.

### BACKGROUND OF THE DISCLOSURE

Existing bags, generally referred to as game bags, for carrying carcass portions, may be operable for storing and hanging the game meat, but they have drawbacks, particularly in lifting, carrying, and maneuvering, that the present disclosure addresses as described below. The desired properties of game bags known to those of ordinary skill in the art include good breathability, quick drying, and adequate strength against bursting.

Embodiments of the present disclosure exhibit the aformentioned desired properties and additionally have an improved structure for handling the bags when they are loaded with the bulky, heavy, and dripping contents. The present disclosure addresses a problem with the existing bags that those of ordinary skill in the art do not recognize or understand.

Game bags are typically loaded with a carcass portion, e.g., a hindquarter of an elk, weighing over 60 pounds and ranging up to the neighborhood of 100 pounds. A moose hindquarter is typically at least 100 to 120 pounds. A bag loaded with such a carcass portion is difficult for an adult human to lift, carry, and maneuver because of the weight and bulk, as well as messy because of the blood and other liquid that drains from the carcass portion. Additionally, the heavier and bulkier end of the carcass portion is typically loaded into the bag first, so the closed end of the bag is heavier. A common scenario with existing game bags loaded in the typical manner is that an average adult human may struggle to lift the closed end of the bag (i.e., the heavier end of the bag) while loading the bag into a transport vehicle such as a truck or airplane. Gripping the fabric of the bag is made more difficult by the bulk, weight, and liquid of the carcass portion. In this struggle some of the bloody liquid leaks out of the bag onto the person lifting it. None of the existing game bag makers address or even recognize this as a problem.

Another drawback of existing game bags of the drawstring variety is that they include only a single drawstring. The single drawstring limits the options for hanging the bag, e.g., from a horizontal meat pole lashed between two trees.

A further disadvantage of existing game bags is that they are configured for carrying by only a single person. A structure on a game bag providing for convenient carrying by two people would be advantageous but the present industry does not recognize this issue.

### BRIEF DESCRIPTION OF THE DRAWINGS

FIG. 1 is a perspective view of an exemplary embodiment of a bag suitable for holding a carcass or portion of a carcass of a game animal, having a substantially rectangular shape with long sides and shorter ends, one of which ends is closed and the other of which is open with a drawstring closure, the closed end having a handling structure roughly centered between the sides.

FIG. 2 is a plan view of the bag similar to that of FIG. 1, in this case with the handling structure off-center at the closed end.

FIG. 3 is a perspective view of the bag of FIG. 1, folded in half along the sides, and showing an adult person using the handling structure by inserting a hand through an opening between the closed end of the bag and a strap that is part of the handling structure, and also showing the stitching that couples the strap to the bag adjacent the closed end.

FIG. 4 is a plan view of another embodiment of a bag in accordance with the present disclosure, with the handling structure including two handles formed by openings through the bag adjacent the closed end and reinforced by stitched in fabric.

FIG. 5 is a perspective view of a bag similar to the bag of FIG. 4, with the fingers of a hand inserted through one of the openings adjacent the closed end of the bag.

FIG. 6 is a plan view of another embodiment of a bag in accordance with the present disclosure, with the handling structure including two handles, one on each side adjacent the closed end of the bag, the handles formed by openings through the bag adjacent the closed end and reinforced by stitching in the fabric.

FIG. 7 is a plan view of another embodiment of a bag in accordance with the present disclosure, with the handling structure including two handles, one on each side adjacent the closed end of the bag, the handles formed by attaching a piece at a side seam of the bag adjacent the closed end of the bag.

FIG. 8 is a plan view of another embodiment, similar to that of FIG. 4, of a bag in accordance with the present disclosure, with an illustration of stitching to reinforce the handling structure adjacent the closed end of the bag, and the handling structure is a single handle as opposed to the two handles shown in FIG. 4.

FIG. 9 is a plan view of another embodiment, similar to that of FIG. 4, of a bag in accordance with the present disclosure, with an illustration of stitching to reinforce the handling structure adjacent the closed end of the bag, and the handling structure is two handles as in FIG. 4.

### DETAILED DESCRIPTION

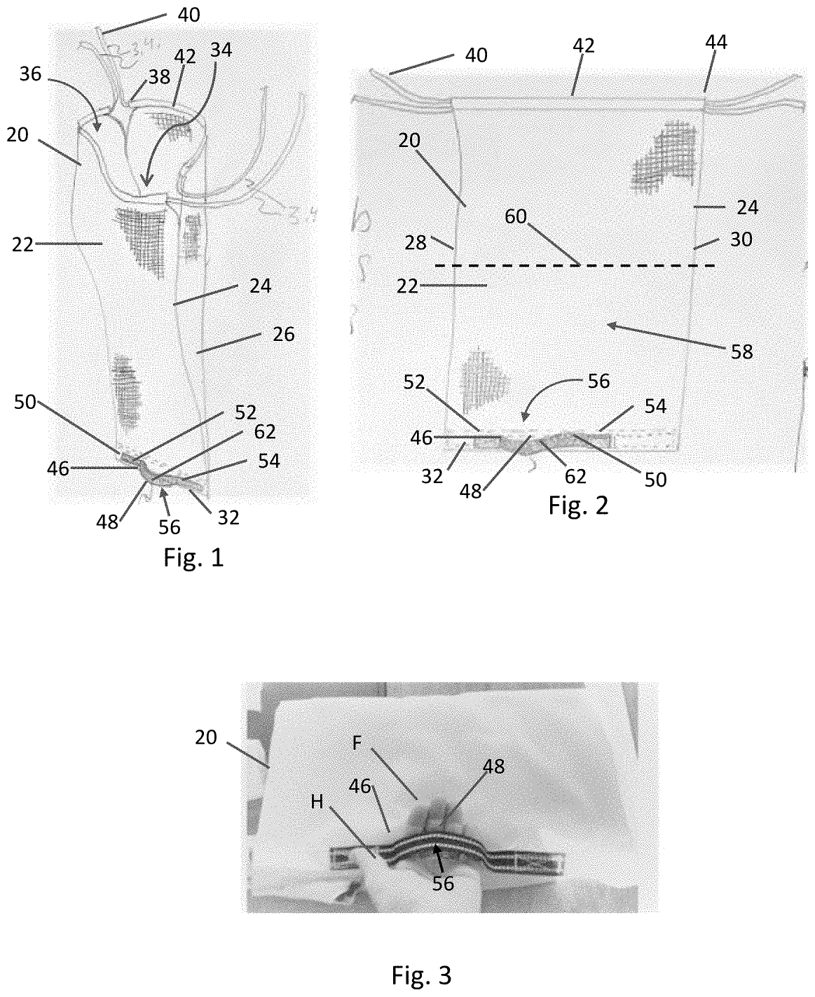

FIGS. 1-9 show examples of a bag 20 in accordance with an embodiment of the present disclosure. Unless otherwise specified, bag 20 may contain, but is not required to contain, at least one of the structures, components, functionalities, concepts, and/or variations described, illustrated, and/or incorporated herein.

Bag 20 may be configured in size and shape to receive a bulky and/or heavy load, such as all or a portion of an animal carcass. The carcass, or portion thereof, may be from a large animal, typically wild game such as a moose, elk, deer, caribou, antelope, wild sheep, such as DaII sheep, bears, or goat. Bag 20 may be substantially rectangular in plan or may have another shape suitable to the expected load to be received and carried. A rectangular bag may be sized, for example, to be about 30″ by about 61″, which is a configuration capable of receiving a moose hindquarter weighing about 120 pounds or more. Further examples of bag sizes and shapes are described below.

Bag 20 may be formed of a first panel 22 joined in a suitable manner such as stitching along a seam 24 to a second panel 26. For example, to construct a rectangular bag, a rectangular first panel may be sewn on two sides 28, 30 and an end 32 to corresponding sides and ends of a second panel with a substantially similar size and shape. Alternatively, any suitable size and shape may be used for each panel, and they may be identical or be varied to create shapes and internal spaces 34 for the bag as suited to a particular purpose. For example, one or both of the panels may have a trapezoidal shape to create a bag with an internal space 34 that is larger at one or the other of ends of the bag. Alternatively, bag 20 may be constructed from a single panel, folded and sewn together along one end and one pair of folded-together sides. Bag 20 may alternatively constructed by more than two panels arranged and bound together in a suitable manner for a particular configuration for the load. Sewing seam 24 may be accomplished using thread of suitable strength using a straight lock stitch. Additional strength may be provided to seam 24 along one or more of the sides and ends by rolling up the edges of the fabric. For example the edges of the panels along closed end 32 may be rolled up as many as four times, or more, before stitching to build in strength to the closed end of the bag, which is typically the bottom of the bag when the carcass is hung to dry.

The panels or other structures making up the bag may be made of any suitable material for containing a bulky and/or heavy load. For example, a duplex nylon fabric, a nylon/cotton blend, Taslan breathable white 4-ply material, and rip-stop fabric (whch may be 100% synthetic) have been found to provide suitable performance for holding and hanging loads exceeding 100 pounds and allowing the moisture from the carcass to pass out of the bag while substantially preventing insect and other infestations from reaching the carcass within the bag.

Generally, bag 20 includes an open end 36 opposite closed end 32. Open end 36 may include a selectively operable closure mechanism 38, such as a drawstring closure 44 formed by one or more drawstrings 40 extending through one or more cuffs 42 adjacent open end 36. In the embodiment of FIGS. 1-7, two drawstrings are used, each inserted through one of two cuffs, each cuff extending along half of open end 36 to make a substantially complete circuit around end 36. Closure mechanism 38 is operable by a user selectively to close open end 36, typically to an extent to prevent the load from passing out through end 36. For example, drawstrings 40 may be pulled relative to bag 20 and cuffs 42 to draw end 36 into a smaller opening. Drawstrings 40 may be tied together to secure end 36 in a closed condition as maybe conventionally done for drawstring closures. Alternatively, bag 20 may be constructed with a single cuff extending substantially all the way around end 36 and a single drawstring may be inserted through the single cuff, and used to selectively close open end 36. Each cuff may be formed by folding over an edge of each panel and stitching the edge to the panel below the fold to form a passageway for the drawstring.

The two-drawstring configuration may provide a greater range of options than the single for tying the drawstrings to one another and to another object, for example for hanging bag 20 from a meat pole for cooling the meat. The two drawstrings may be tightened on the bag and the ends thereof may be wrapped around the meat pole and tied to one another on top of the meat pole, and untied, in a manner similar to tying and untying shoelaces.

The drawstring(s) may be made of any suitable material for moving relative to the cuff, cinching the open end, and supporting the loaded bag by hanging from the drawstring(s). For example, the drawstring(s) may be made of nylon ripcord material and may include a silver reflective stripe running along at least a portion of the length to aid the visibility of the bag in an outdoor, day or nighttime, environment.

Bag 20 may include a handling structure 46 adjacent to closed end 32, for example a single handle 48 coupled to bag 20 along closed end 32. Single handle 48 may centered on end 32, or off-center, as best suited to a particular application for the bag.

Handle 48 may be formed from a strip of fabric 50 coupled at each of two ends 52, 54 by stitching or other suitable means, and with a central portion 62 spaced from bag 20. Handling structure 46 may be formed of any material and coupled to bag 20 in any manner suitable for use of handling structure 46 for lifting and carrying bag 20 adjacent end 32. For example, handling structure 46 may be formed using a polypropylene and/or a ballistic nylon material. Handling structure 46 may include one or more reflective stripes running along at least a portion of the length to aid the visibility of the bag at a distance in an outdoor, day or nighttime, environment.

Handling structure 46 may be stitched to bag by thread of suitable strength. For example, the sewing may be performed using a straight lock stitch and may further include a square stitch on one or both sides of the handles for reinforcement.

FIG. 3 illustrates for handle 48, as typical of handling structure 46, that central portion 62 creates an opening 56 between handle 48 and bag 20 adjacent end 32, which allows for a user to insert the fingers F of hand H through opening 56 and grasp handle 48. This allows the user to lift, carry, and/or maneuver bag 20 adjacent end 32. Thus, opening 56 is typically at least about 4-6″ in length and at least about 0.5″ in width.

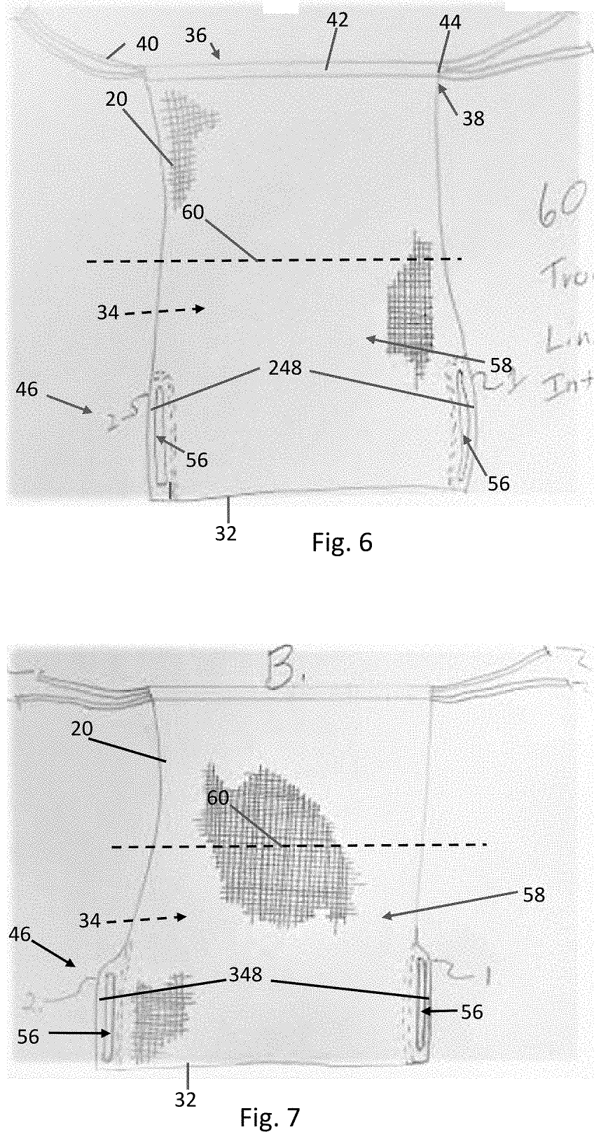

Handling structure 46 is typically provided in a lower half 58 of bag 20 below a midline 60. The location in this lower half may vary depending on the particular structure of the carcass or portion thereof for which the bag is designed. Typically handling structure 46 runs along end 32 (as in FIGS. 1-5) or has one side at end 32 (see FIGS. 6-7) and extends away from end 32.

Bag 20 may have a load inserted into internal space 34 and open end 36 may be selectively closed by drawstrings 40. With a load inserted, handling structure 46 may be used to maneuver closed end 32 of bag 20 relative to end 36 by a user holding handling structure 46 with one hand H. The user may also,with the other hand, hold bag 20 adjacent end 36 using drawstring 40, and/or the bag structure adjacent closure 44, and, in so holding the bag, handling structure 46 allows the user to maneuver bag 20 so as to maintain separation between the user and the bag, including at the lower end. Handling structure 46 also aids in maintaining separation where the user is holding it and another user is holding upper end of the bag at or adjacent the drawstring Handling structure 46 in the bottom of the bag and/or in the lower half of the bag aids in helping to lift the back half of the heavy carcass and reduce the chances of the user getting bloody from the carcass while moving it to and from a transport vehicle, such as a cart, ATV, truck, boat, or plane.

One or more of bags 20 may be provided in a pouch constituting a kit 102 of several bags 20 for carrying on a hunting trip. Bags 20 may be provided in various shapes and sizes to provide kits configured for use with variously sized game animals. The kits may include bags of various number, shapes, and sizes as suited for a particular application, including the following examples:

Kit Content with approximate bag sizes:

Moose kit
Four quarter bags 30″ by 61″
Two meat bags. 44″ by 30″
One Back-strap & Tenderloin bag 27″ by 30″

Kit for caribou, elk or wild goat
4-28″×48″ Quarter Bags
1-23″×30″ Burger bag
1-12″×21″ Tenderloin & Back-strap bag

Kit for deer, black bear, Dall sheep
4-20″×30″ Quarter Bags
1-16″×20″ Meat Parts Bag
1-14″×23″ Camp Meat Bag

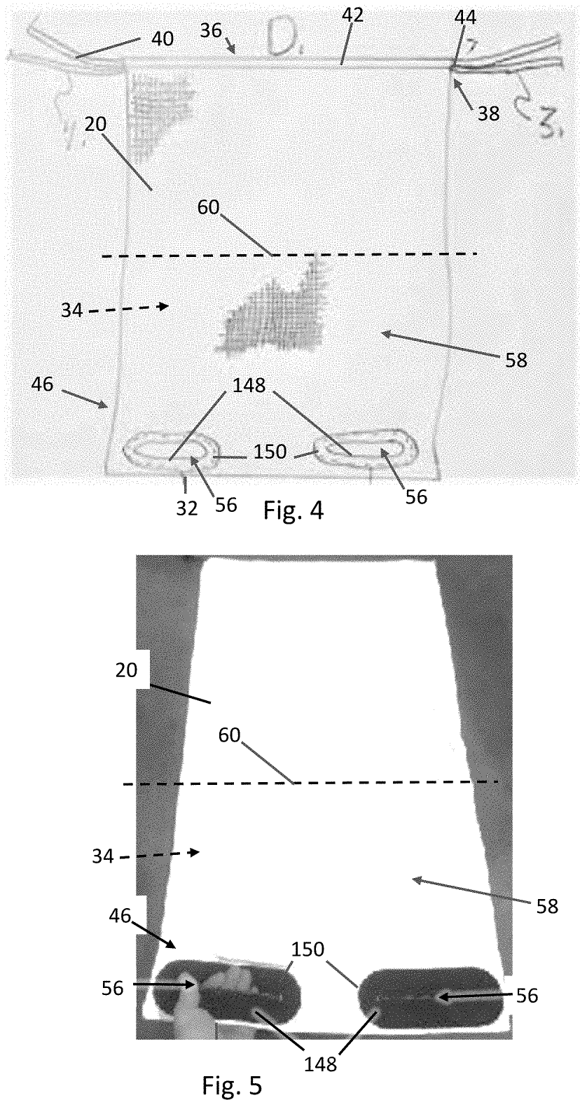

FIGS. 4-7 illustrate bags 20 where handling structure 46 may include more than one handle, which may be used simultaneously by two or more users. For example, as will be further described, the bags of FIGS. 4-7, and in particular the bags of FIGS. 6-7 facilitate two people carrying the bag, one on each side, as opposed to only front and back.

As shown in FIGS. 4-7, bag 20 includes an open end 36 with a selectively operable closure mechanism 38, such as a drawstring closure 44 formed by one or more drawstrings 40 extending through one or more cuffs 42 adjacent open end 36. The drawstring closure may be operable and have corresponding features as for the embodiment of FIGS. 1-3.

Handling structure 46 adjacent to closed end 32 includes in the embodiment of FIGS. 4-5 a pair of handles 148 along closed end 32. Handles 148 may be centered on end 32, or off-center, as best suited to a particular application for the bag. In this embodiment, two handles are shown and a greater number of handles may be provided as suited to a particular application for the bag.

One or both of handles 148 may be formed by openings 56 through bag 20 and the openings may be separated from interior space 34 of bag 20 by stitching. Handles 148 may be reinforced by fabric 150 coupled to bag 20 adjacent each opening 56, for example, by appropriate stitching. Fabric 150, which may be provided with a doughnut or other appropriate shape with an opening corresponding to each opening 56. Any suitable material may be used for fabric 150, such as a polypropylene and/or a ballistic nylon material, and may be provided with one or more reflective stripes to aid the visibility of the bag at a distance in an outdoor, day or nighttime, environment.

Handling structure 46 in this embodiment may be stitched by thread of suitable strength. For example, the sewing may be performed using a straight lock stitch and may further include a square stitch on one or both sides of the handles for reinforcement.

FIG. 6 illustrates for handle 148, as another example of handling structure 46, that opening 56 adjacent end 32 allows for a user to insert the fingers F of hand H through opening 56 and to grasp handle 148. This allows the user to lift, carry, and/or maneuver bag 20 adjacent end 32. Thus, opening 56 in this embodiment is typically at least about 4-6″ in length and at least about 0.5″ in width.

Handling structure 46 in the embodiment of FIGS. 4-7 is typically provided in a lower half 58 of bag 20 below a midline 60. The location in this lower half may vary depending on the particular structure of the carcass or portion thereof for which the bag is designed. Handling structure 46 in this embodiment runs along end 32 and other configurations may be used as chosen for another application for the bag.

FIGS. 6 and 7 illustrate double handle bags in which handling structure may be stitched into the bag or attached to the bag along the sides of the bag. As shown in FIGS. 6 and 7m bag 20 includes an open end 36 with a selectively operable closure mechanism 38, which may be operable and have corresponding features as for the other embodiments.

Handling structure 46 adjacent to closed end 32 includes in the embodiment of FIG. 6 a pair of handles 248 adjacent closed end 32, and running along the side edge with one end of the handle at closed end 32 and the other end up the side edge. Alternatively a single one of handles 248 may be provided. As in other embodiments, the positioning of the handle(s) is typically in the lower half 58 of the bag and number of handles and their location and direction may be provided as best suited to a particular application for the bag.

One or both of handles 248 may be formed by openings 56 through bag 20 and the openings may be separated from interior space 34 of bag 20 by stitching. Handles 248 may be reinforced by fabric and/or stitched by thread of suitable strength as in the embodiment of FIGS. 4 and 5.

In the embodiment of FIG. 7, handling structure 46 may be adjacent to closed end 32 and include a pair of handles 348 adjacent closed end 32, and running along the side edge with one end of the handle at closed end 32 and the other end up the side edge. Alternatively, a single one of handles 348 may be provided. As in other embodiments, the positioning of the handle(s) is typically in the lower half 58 of the bag and number of handles and their location and direction may be provided as best suited to a particular application for the bag.

One or both of handles 348 may be formed by openings 56 through bag 20, as in FIGS. 4-5 and/or by attached strips of fabric as in FIGS. 1-3. Handles 348 may be separated and/or reinforced with stitching and fabric as for the other embodiments.

The embodiments of FIGS. 6 and 7 may be used by inserting the fingers F of hand H through opening 56 similarly as for FIGS. 1-5. Thus, opening 56 in these embodiments is typically at least about 4-6″ in length and at least about 0.5″ in width.

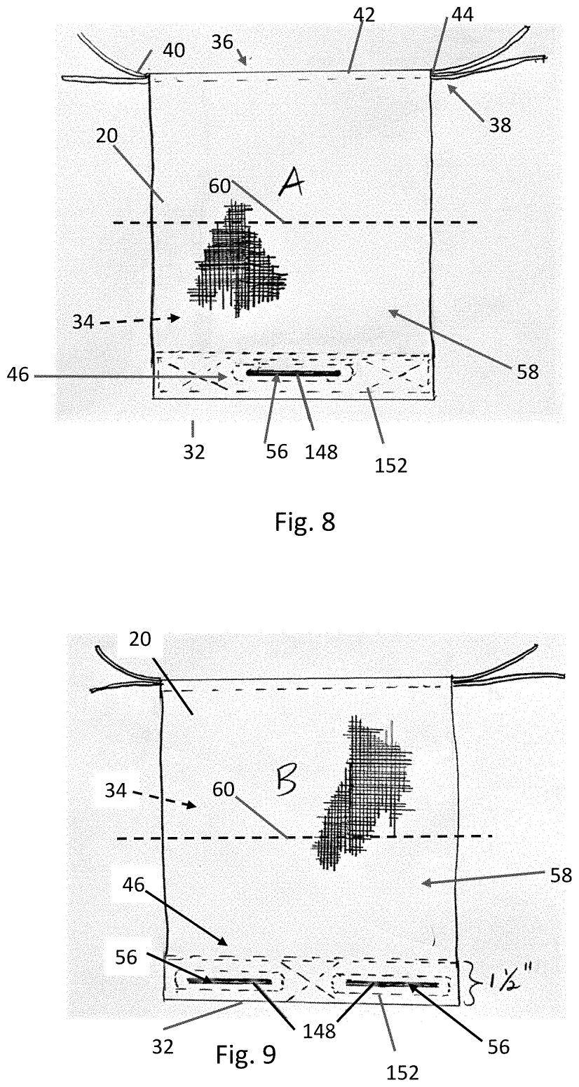

Further embodiments, similar to those of FIGS. 4 and 5, and that provide a weight reduction relative to those, are shown in FIGS. 8 and 9. These embodiments are generally the same as those of FIGS. 4 and 5, and include, in place of reinforcing fabric 150, reinforcing stitching 152, in an area adjacent end 32. The area where the stitching is provided may be along a strip adjacent end 32 and may extend, for example, about 1.5-inches away from end 32.

It should be appreciated that although selected embodiments of the representative game bags are disclosed herein, numerous variations of these embodiments may be envisioned by one of ordinary skill that do not deviate from the scope of the present disclosure. The presently disclosed bags are well suited to a variety of load receiving, carrying, and maneuvering applications.

It is believed that the disclosure set forth herein encompasses multiple distinct inventions with independent utility. While each of these inventions has been disclosed in its preferred form, the specific embodiments thereof as disclosed and illustrated herein are not to be considered in a limiting sense as numerous variations are possible. Each example defines an embodiment disclosed in the foregoing disclosure, but any one example does not necessarily encompass all features or combinations that may be eventually claimed. Where the description recites “a” or “a first” element or the equivalent thereof, such description includes one or more such elements, neither requiring nor excluding two or more such elements. Further, ordinal indicators, such as first, second or third, for identified elements are used to distinguish between the elements, and do not indicate a required or limited number of such elements, and do not indicate a particular position or order of such elements unless otherwise specifically stated. Novel and non-obvious combinations and subcombinations of features, functions, elements and/or properties disclosed herein may be claimed through presentation of claims in a related application.

We claim:

1. A bag configured to receive and hold contents at least as heavy and bulky as a portion of a large animal carcass, the bag configured to be carried by a person, the bag including:
i. a containing portion defining a closed end, an open end opposite the closed end, and a side portion interconnecting the closed end and the open end, and further wherein the open end is configured for operation between a holding configuration for holding the carcass portion in the bag and a passing configuration for passing the carcass portion through the open end;
ii. a closure mechanism adjacent the open end for selectively closing the open end to provide the holding configuration and opening the open end to provide the passing configuration;
wherein the bag defines a midline between the open end and closed end and further wherein the bag includes a handling structure positioned on the closed end side of the midline.

2. The bag of claim 1 further wherein the handling structure is adjacent the closed end.

3. The bag of claim 2, further wherein the handling structure is at the closed end.

4. The bag of claim 3, further wherein the handling structure includes a strip of fabric defining a first and a second end, wherein the first and second ends are coupled to the closed end of the bag, the strip of fabric providing a handle between the first and second ends.

5. The bag of claim 1 further wherein the side portion defines a length between the closed end and the open end, and wherein the side portion length is at least about 61-inches.

6. The bag of claim 1 further wherein the closed end defines a width, and wherein the closed end width is at least about 30-inches.

7. The bag of claim 1 further wherein the side portion defines a length between the closed end and the open end, and wherein the side portion length is at least about 48-inches.

8. The bag of claim 1 further wherein the side portion defines a length between the closed end and the open end, and wherein the side portion length is at least about 30-inches.

9. The bag of claim 1 wherein the closure mechanism includes a drawstring.

10. The bag of claim 1 wherein the closure mechanism includes a pair of drawstrings.

11. The bag of claim 1 wherein the bag defines an internal space and further wherein the open end provides the only access to the internal space.
